(19) United States
(12) Patent Application Publication
(10) Pub. No.: US 2015/0072665 A1
(43) Pub. Date: Mar. 12, 2015

(54) Cloud Caller ID Display System and Method Thereof

(71) Applicants: INVENTEC APPLIANCES (PUDONG) CORPORATION, Shanghai (CN); INVENTEC APPLIANCES (SHANGHAI) CO. LTD., Shanghai (CN); INVENTEC APPLIANCES (NANCHANG) CORPORATION, Jiangxi (CN); INVENTEC APPLIANCES CORP., Taipei County (TW)

(72) Inventors: Qing WU, Jiangxi (CN); Ying HU, Jiangxi (CN); Xiao-Long XU, Jiangxi (CN)

(73) Assignees: INVENTEC APPLIANCES (PUDONG) CORPORATION, Shanghai (CN); INVENTEC APPLIANCES (SHANGHAI) CO. LTD., Shanghai (CN); INVENTEC APPLIANCES (NANCHANG) CORPORATION, Jiangxi (CN); INVENTEC APPLIANCES CORP., Taipei County (TW)

(21) Appl. No.: 14/289,442

(22) Filed: May 28, 2014

(30) Foreign Application Priority Data
Sep. 9, 2013 (CN) 201310408088.6

(51) Int. Cl. H04M 3/42; H04W 4/12

(52) U.S. Cl. CPC H04M 3/42042; H04W 4/12
USPC 455/415

(57) ABSTRACT

A cloud caller ID display system includes a cloud serving apparatus, a first mobile communication device and a second mobile communication device. The first mobile communication device is used for transmitting a first contact list to the cloud serving apparatus. The second mobile communication device is used for obtaining the first contact list from the cloud serving apparatus, wherein upon receiving a communication request from an external communication device, the second mobile communication device is configured to match a caller ID of the external communication device in the first contact list to search for a contact name corresponding to the caller ID, thereby enabling displaying the found contact name on the second mobile communication device.

### CROSS-REFERENCE TO RELATED APPLICATION

This application claims the benefit of China Patent Application No. 201310408088.6, filed on Sep. 9, 2013, which is hereby incorporated by reference for all purposes as if fully set forth herein.

### BACKGROUND

1. Field of the Invention

The present invention relates to a caller ID display system which shares contact lists of cell phones through the cloud, and more particularly, to a cloud caller ID display system and a method thereof, which shares contact lists of cell phones by a cloud server.

2. Related Art

With the society developing, people need to make contact with more and more people, and it becomes a problem to store and manage the information of contacts.

Generally speaking, for storing and managing the information of contacts, people mostly use keypads to input the information of contacts in cell phones. However, with the improving of electronic technologies, smart phones are widespread nowadays, and contact management systems for integrating various communication software, community websites and emails on smart phones are launched; therefore, as a result of wide using various communication software, community websites and emails, frauds increase day by day. In addition, except for contacts which have been stored, smart phones only display phone numbers, so that the identity of the caller will not be recognized. Thus, even if a call is from a known caller, it will be ignored because of no record in the contact list, which may lead to missing important phone calls.

### SUMMARY

The present invention provides a cloud caller ID display system and a method thereof, for improving the convenience of identifying caller identities by sharing contact list on the cloud.

The present invention provides a caller ID display system for use in a cloud or Internet, including a cloud serving apparatus, a first mobile communication device and a second mobile communication device. The first mobile communication device is configured for transmitting a first contact list to the serving apparatus. The second mobile communication device is configured for obtaining the first contact list from the serving apparatus, wherein upon receiving a communication request from an external communication device, the second mobile communication device is configured to match a caller ID of the external communication device in the first contact list to search for a contact name corresponding to the caller ID, thereby enabling displaying the found contact name on the second mobile communication device.

In one embodiment, the first mobile communication device further comprises a first input unit used for selecting a plurality of contacts on the first mobile communication device to be included in the first contact list. And the first mobile communication device may further be configured to set through the first input unit whether the second mobile communication device have authority to access the first contact list.

In one embodiment, the first contact list is to be edited by the first mobile communication device only.

In one embodiment, the second mobile communication device has a second contact list, and the second mobile communication device can display the caller ID if a contact name corresponding to the caller ID is not found in the first and second contact lists.

The present invention also provides a caller ID display system for use in a cloud or Internet, comprising a serving apparatus and a mobile communication device. The mobile communication device is configured for obtaining a contact list from the serving apparatus which is transmitted by another mobile communication device, wherein upon receiving a communication request from an external communication device, the mobile communication device is configured to match a caller ID of the external communication device in the first contact list to search for a contact name corresponding to the caller ID, thereby enabling displaying the contact name on the mobile communication device.

The present invention further provides a method for use in a cloud or Internet for matching a caller ID, comprising connecting a mobile communication device to a serving apparatus; the mobile communication device obtaining a first contact list from the serving apparatus, to which the first contact list is transmitted from another mobile communication device; the mobile communication device receiving a communication request from an external communication device; and matching a caller ID of the external communication device in the first contact list to search for a contact name corresponding to the caller ID, wherein the found contact name may be displayed on the mobile communication device.

In one embodiment, the first contact list includes a plurality of contacts selected from the another mobile communication device, which sets whether the mobile communication device have authority to access the first contact list before transmitting the first contact list to the serving apparatus.

In one embodiment, the step of obtaining the first contact list by the mobile communication device comprises: checking whether the mobile communication device has authority to access the first contact list.

In one embodiment, the method further includes the mobile communication device matching the caller ID of the external communication device in a second contact list available on the mobile communication device, to search for a contact name corresponding to the caller ID, wherein the found contact name may be displayed on the mobile communication device.

In one embodiment, the method further includes displaying the caller ID on the mobile communication device.

### BRIEF DESCRIPTION OF THE DRAWINGS

FIG. 1 is a block diagram of a caller ID display system for use in the cloud according to the present invention;

FIG. 2 is a drawing of FIG. 1 according to an embodiment of the present invention;

FIG. 3 is a flow chart of a method for use in the cloud for matching a caller ID according to the present invention;

FIGS. 4-6 are flow charts of FIG. 3.

### DETAILED DESCRIPTION

To understand the above feature and advantages of the present invention, reference will now be made in detail to the preferred embodiment of the present disclosure, examples of which are illustrated in the accompanying drawings. The accompanying drawings are simplified drawings schematically drawn for the purpose of describing basic structure of the present invention.

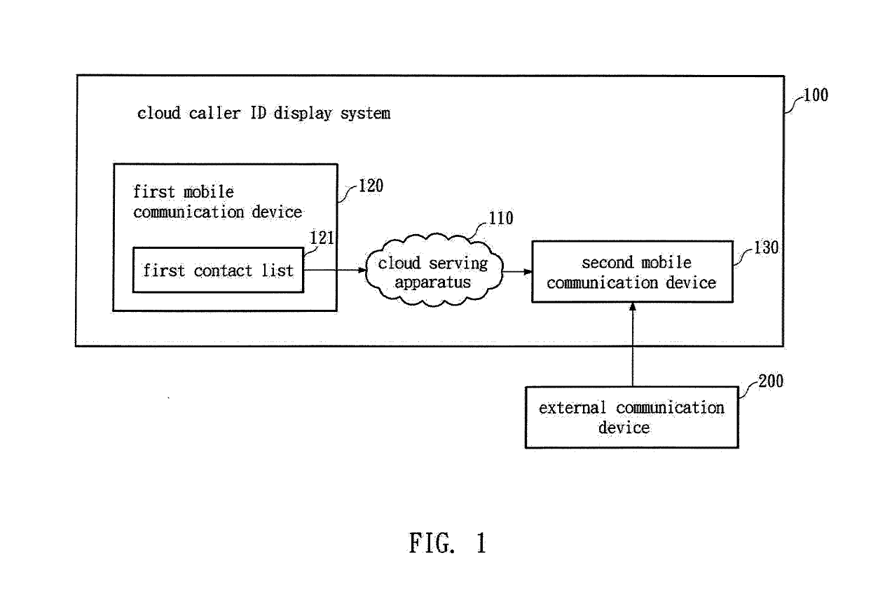

FIG. 1 is a block diagram of a caller ID display system for use in the cloud according to the present invention. Referring to FIG. 1, a cloud caller ID display system 100 comprises a cloud serving apparatus 110, a first mobile communication device 120 and a second mobile communication device 130. The first mobile communication device 120 is configured for transmitting a first contact list 121 to the cloud serving apparatus 110. The second mobile communication device 130 is configured for obtaining the first contact list 121 from the cloud serving apparatus 110, wherein upon receiving a communication request from an external communication device 200, the second mobile communication device 130 matches a caller ID of the external communication device 200 in the first contact list 121 to search for a contact name corresponding to the caller ID, thereby enabling displaying the found contact name on the second mobile communication device 130.

In one embodiment, the first mobile communication device 120 further comprises an input unit used for selecting a plurality of contacts on the first mobile communication device 120 to be included in the first contact list 121. Further, the first mobile communication device 120 sets through the first input unit whether the second mobile communication device 130 have authority to access the first contact list 121, moreover, the first contact list 121 is to be edited by the first mobile communication device 120 only.

In one embodiment, the second mobile communication device 130 further has a second contact list, and the second mobile communication device 130 displays the caller ID if a contact name corresponding to the caller ID is not found in the first contact list 121 and the second contact list. Besides, the second mobile communication device 130 has a second input unit for selecting a plurality of contacts on the second mobile communication device 130 to be included in the second contact list, and the second mobile communication device 130 may transmit the second contact list to the cloud serving apparatus 110.

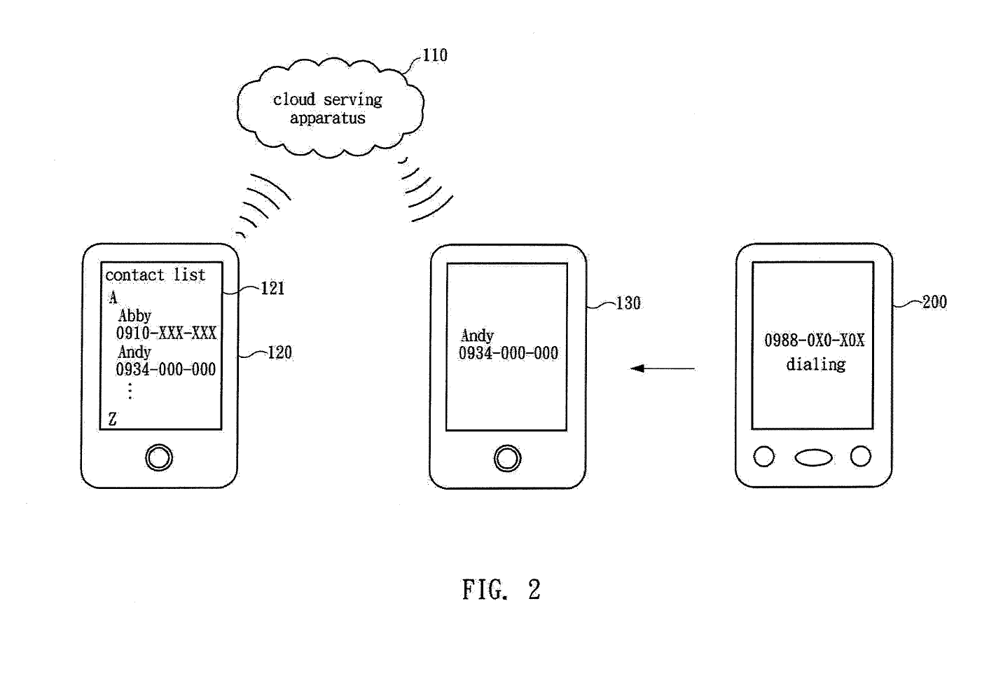

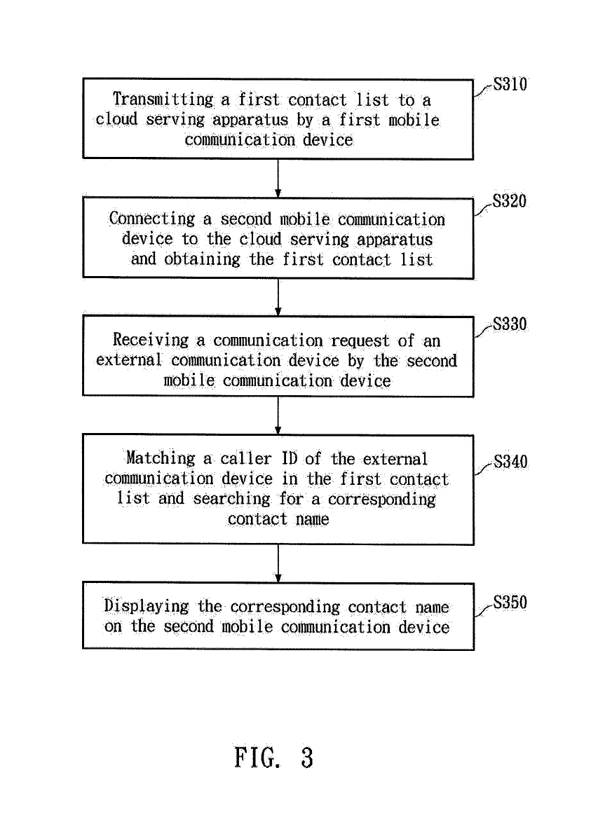

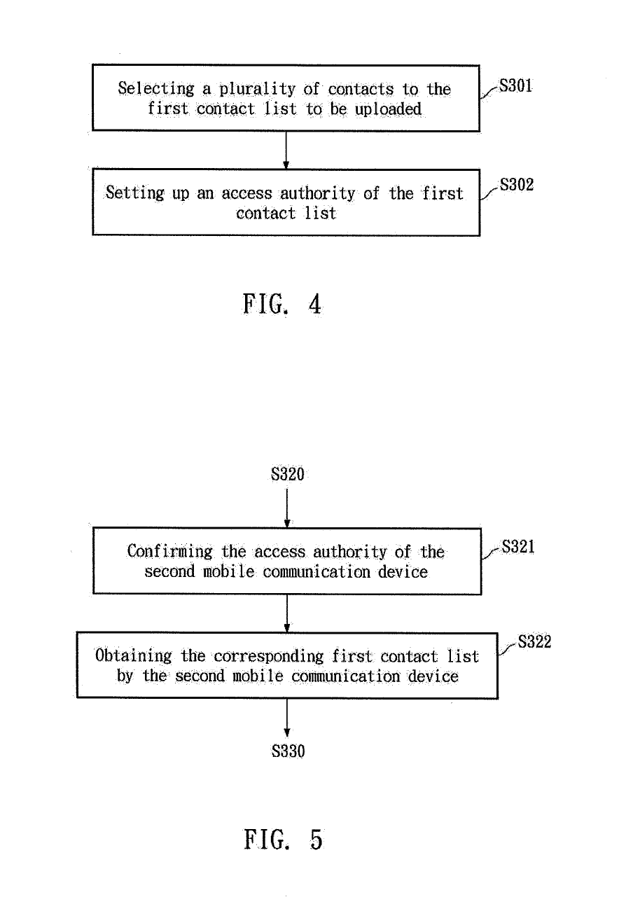

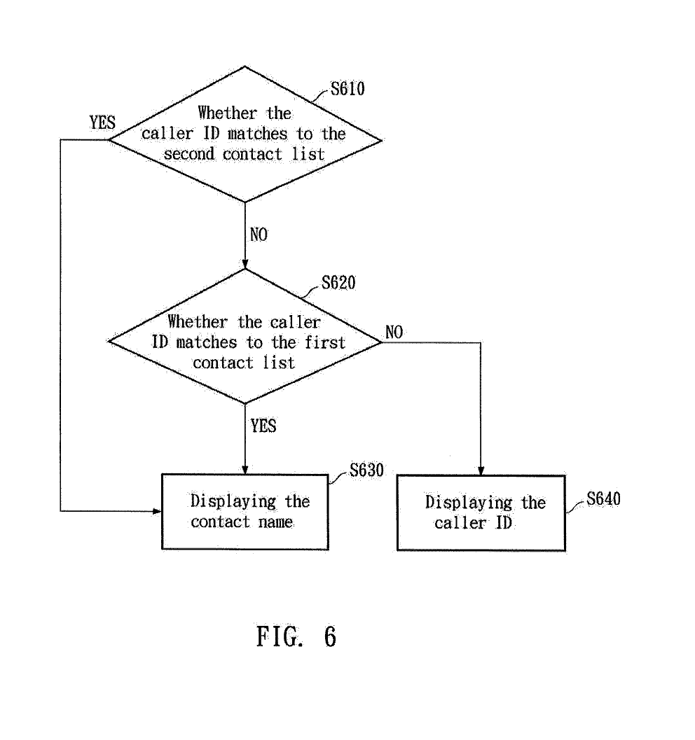

In one embodiment, the second mobile communication device 130 is configured to set through the second input unit authority to access the second contact list, wherein the second contact list is to be edited by the second mobile communication device 130 only and the second mobile communication device 130 may share the second contact list with the cloud serving apparatus 110. Referring to FIGS. 2-6 together, FIG. 2 is a drawing of FIG. 1 according to the present invention. FIG. 3 is a flow chart of a caller ID display system for use in the cloud according to the present invention. FIGS. 4-6 are flow charts of FIG. 3, and please refer to flow charts in FIGS. 3-6 corresponding to the drawing in FIG. 2. In FIG. 3, the first mobile communication device 120 transmits a first contact list 121 to a cloud serving apparatus 110 (Step S310). In the Step S310, it further comprises a plurality of contacts is selected to the first contact list 121 to be uploaded (Step S301) and an access authority of the first contact list 121 is set up (Step S302) as shown in FIG. 4.

Then, the second mobile communication device 130 is connected to a cloud serving apparatus 110 and the first contact list 121 is obtained by the second mobile communication device 130 (Step S320). Referring to FIG. 4, the first mobile communication device 120 is configured to set an access authority of the uploaded the first contact list 121. Therefore, if the second mobile communication device 130 requires the first contact list 121, the access authority of the second mobile communication device 130 needs to be confirmed (Step S321) so as to obtain corresponding first contact list 121 (Step S322).

Next, a communication request of an external communication device 200 is received by the second mobile communication device 130 (Step S330). Then, a caller ID of the external communication device 200 is matched to the first contact list 121 so as to search a corresponding contact name (Step S340), and then the corresponding contact name is displayed on the second mobile communication device 130 (Step S350).

Further, a method for use in the cloud for matching a caller ID may also comprise the steps as following:

Step S610: a caller ID is matched to the second contact list of the second mobile communication device 130, and if the caller ID is matched in the second contact list, Step S630 will be performed; otherwise, Step S620 will be performed.

Step S620: the caller ID is matched to the first contact list 121, and if the caller ID is matched in the first contact list 121, Step S630 will be performed; otherwise, Step S640 will be performed.

Step S630: the contact name is displayed on the second mobile communication device 130.

Step S640: the caller ID is displayed on the second mobile communication device 130.

By using the cloud caller ID display system and the method thereof of the present invention, when a communication device receives a calling request from an external communication device, even though the communication device does not have identity information corresponding to a caller ID of the external communication device, the communication device may still obtain the identity information of the caller ID from the contact list of a cloud server in order to help the user of the communication device to identify whether the calling request is from a stranger. In addition, the contact lists stored in the cloud server according to the present invention allow an access authority setting, so that the communication device may obtain the contact identity information of the contact list only if the communication device is permitted so as to ensure the privacy of the contacts in the contact list.

The previous description of the preferred embodiment is provided to further describe the present invention, not intended to limit the present invention. Any modification apparent to those skilled in the art according to the disclosure within the scope will be construed as being included in the present invention.

What is claimed is:

1. A caller ID display system for use in a cloud or Internet, comprising:
a serving apparatus;
a first mobile communication device, configured for transmitting a first contact list to the serving apparatus; and
a second mobile communication device, configured for obtaining the first contact list from the serving apparatus, wherein upon receiving a communication request from an external communication device, the second mobile communication device is configured to match a caller ID of the external communication device in the first contact list to search for a contact name corresponding to the caller ID, thereby enabling displaying the found contact name on the second mobile communication device.

2. The caller ID display system according to claim 1, wherein the first mobile communication device further comprises a first input unit for selecting a plurality of contacts on the first mobile communication device to be included in the first contact list.

3. The caller ID display system according to claim 2, wherein the first mobile communication device is configured to set through the first input unit whether the second mobile communication device have authority to access the first contact list.

4. The caller ID display system according to claim 1, wherein the first contact list is to be edited by the first mobile communication device only.

5. The caller ID display system according to claim 1, wherein the second mobile communication device has a second contact list, and the second mobile communication device can display the caller ID if a contact name corresponding to the caller ID is not found in the first and second contact lists.

6. The caller ID display system according to claim 5, wherein the second mobile communication device further comprises a second input unit for selecting a plurality of contacts on the second mobile communication device to be included in the second contact list.

7. The caller ID display system according to claim 5, wherein the second mobile communication device is configured for transmitting the second contact list to the serving apparatus.

8. The caller ID display system according to claim 5, wherein the second mobile communication device is configured to set through the second input unit authority to access the second contact list.

9. The caller ID display system according to claim 5, wherein the second contact list is to be edited by the second mobile communication device only.

10. The caller ID display system according to claim 5, wherein the second mobile communication device is configured to share the second contact list with the serving apparatus.

11. A caller ID display system for use in a cloud or Internet, comprising:
a serving apparatus; and
a mobile communication device, configured for obtaining a contact list from the serving apparatus which is transmitted by another mobile communication device, wherein upon receiving a communication request from an external communication device, the mobile communication device is configured to match a caller ID of the external communication device in the first contact list to search for a contact name corresponding to the caller ID, thereby enabling displaying the contact name on the mobile communication device.

12. A method for use in a cloud or Internet for matching a caller ID, comprising:
connecting a mobile communication device to a serving apparatus;
obtaining, by the mobile communication device, a first contact list from the serving apparatus, to which the first contact list is transmitted from another mobile communication device;
receiving, by the mobile communication device, a communication request transmitted from an external communication device; and
matching, by the mobile communication device, a caller ID of the external communication device in the first contact list to search for a contact name corresponding to the caller ID, wherein the found contact name may be displayed on the mobile communication device.

13. The method for matching a caller ID according to claim 12, wherein the first contact list includes a plurality of contacts selected from the another mobile communication device, which sets whether the mobile communication device have authority to access the first contact list before transmitting the first contact list to the serving apparatus.

14. The method for matching a caller ID according to claim 12, wherein the step of obtaining the first contact list by the mobile communication device comprises:
checking whether the mobile communication device has authority to access the first contact list.

15. The method for matching a caller ID according to claim 12, further comprising:
matching, by the mobile communication device, the caller ID of the external communication device in a second contact list available on the mobile communication device, to search for a contact name corresponding to the caller ID, wherein the found contact name may be displayed on the mobile communication device.

16. The method for matching a caller ID according to claim 12, further comprising:
displaying the caller ID on the mobile communication device.
